(19) United States
(12) Patent Application Publication
(10) Pub. No.: US 2003/0135432 A1
(43) Pub. Date: Jul. 17, 2003

(54) Method and apparatus for managing the delivery and return of goods

(76) Inventors: Henry F. McIntyre, Louisville, KY (US); Michael E. Britt, Louisville, KY (US); James Michael Cavenaugh, Louisville, KY (US); Michael Frohme, Louisville, KY (US); Inna Dzhishkaryani, Louisville, KY (US); Thomas Brian Gambill, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/047,950

(22) Filed: Jan. 15, 2002

(51) Int. Cl. G06F 17/60

(52) U.S. Cl. 705/28

(57) ABSTRACT

A computerized system and method for managing electronic data over a telecommunications medium indicative of consumer-related and product-related information pertaining to the transport of a product or products between a point of origin and a point of destination. The computerized system includes a database containing consumer-related and product-related data files that may be used for generating bills of lading, return authorizations, and delivery and return barcode labels. A portable computing device is provided that is capable of scanning barcodes. A person delivering a product or picking up a product for return may use the portable computing device to scan a unique customer number associated with the delivery or return. Delivery and return barcode labels may include a unique customer number and the associated product's model and serial numbers. Barcode labels are also provided so that a person picking up a product for return may scan various barcodes expressing data indicative of the reason for returning the product, whether the product is damaged, where the product is damaged as well as other information pertaining to the product being returned. Data entered into the portable computing device may be downloaded into a remote computer for transmittal over a telecommunications medium to a central computer system. A data processing module of the computer system updates or populates records of the database that are associated with the data input into the portable computing device. If a product is being returned the consumer is credited for the return when all conditions for an authorized return are met. A notification may then be sent to a financial services group to account for the consumer being credited for the return. A notification may also sent to a financial services group for events that require an adjustment to a customer's invoice such as the customer requesting services be performed during delivery of product that are in addition to what was on an original customer order.

### BACKGROUND OF THE INVENTION

This invention relates in general to the management of electronic data over a telecommunications or electronic network medium and more specifically to a method and system for managing electronic data pertaining to the efficient delivery and return of goods between a point of origin and a point of destination.

Managing the delivery and/or return of goods, such as home appliances or other products, by manufacturers, distributors, retailers and/or other entities within a chain of distribution has traditionally been a labor-intensive endeavor with high costs and a high volume of associated paper transactions. The advent of electronic data processing helped defray some associated costs and reduce paper transactions; however, current methods still rely to a great extent on the manual entry of electronic data at multiple points in the management process. Such electronic data is typically indicative of consumer related and product related information. It may also be indicative of other data associated with a transaction such as shipping information pertaining to a product or products.

Manufacturers of consumer goods have long recognized the importance of cultivating loyalty with their business partners such as transportation companies, distributors, retailers and especially customers. Customer loyalty is crucial especially in increasingly competitive marketplaces. Providing high quality, cost effective and reliable consumer goods is a critical factor in a manufacturer's ability to attract and retain customers over the long term. Another critical factor is providing high quality customer service. Customer service is important regardless of the consumer good in question. It may be particularly important for higher cost goods such as home appliances, for example, especially when customer service includes delivering the good to the consumer and picking it up in the event the good needs to be returned for credit, exchanged or repaired. Purchasing a home appliance such as a refrigerator, stove, washer, dryer or dishwasher, for example, is a major purchasing decision for the typical household and accounts for a significant portion of the household's disposable income. Consequently, manufacturers are keenly aware of the need to ensure the consumer is satisfied with the purchase in order to meet sales and customer retention goals.

Because some home appliances are relatively high cost items, the typical consumer may purchase them on credit. Credit is available from a variety of sources including major manufacturers. After a major purchase, consumers are usually anxious to get the new product into their household to use in their day-to-day household operation. For instance, if a consumer purchases a new refrigerator it may be because the old refrigerator in their household stopped operating properly. In this event, there is an urgent need to deliver the new refrigerator in a timely manner so the household does not experience a significant disruption in its operation.

After delivery of a consumer good to a household by a manufacturer or an authorized representative, the good sometimes needs to be returned due to product failure, damage, the product did not meet the consumer's expectations or for a variety of other reasons. In this event, especially with a major appliance failure that the consumer may rely on for day-to-day household operation, it is critical that the manufacturer or authorized representative respond quickly. Regardless of the reason for the return, the consumer may be anxious to receive proper credit for the purchased product. This is particularly true if the product is being returned specifically for credit rather than for repair or exchange.

Current methods for providing consumers a credit for a return may include multiple steps and may involve the processing of numerous paper transactions. For example, if a household product is being returned, a driver may pick up the unit and fill out paper forms associated with the return. The product may then be taken by the driver to a warehouse who gives those paper forms to an operator at the warehouse. The operator may check in the unit and give the paper forms to a back office operation. The back office may then enter the information from the paper forms into an electronic data base file. A computer program may then process the information from the data file to determine whether to credit the associated consumer for the return. If this process detects an error then the credit will not be provided until the error is corrected. Such a return/credit approval process may take too long in the consumer's mind leading to customer dissatisfaction and diminished customer loyalty. It is not uncommon for the credit approval cycle to take up to a few weeks.

In view of the above, it would be highly advantageous to provide a method and system for managing electronic data to ensure the efficient and timely delivery and/or return of goods between a point of origin and a point of destination in a chain of distribution. It is also desirable to ensure that a purchaser in the chain is properly and timely credited for a return.

### BRIEF SUMMARY OF THE INVENTION

One exemplary embodiment of a method of the present invention allows for managing electronic data over a telecommunications medium indicative of information pertaining to the transport of a product or products between a point of origin and a point of destination, such as the delivery and/or return of appliances between a retailer or delivery service center and a customer. A database may be provided that contains customer-related and product-related information associated with product(s). The method may include the step of inputting a unique customer number into a portable computing device such as a handheld scanner, for example. The unique customer number may be associated with the database containing customer related and product related information. The method also allows for entry into the portable computing device of electronic data indicative of a reason code for each good that is being returned from the point of destination to the point of origin. By way of example, a product may be returned when a customer at the point of destination does not accept delivery of the product or when a customer requests that a product be returned after the customer accepts delivery of the product. The electronic data entered into the portable computing device may be transmitted over the telecommunication medium to update associated records contained in the database on the centralized computerized system.

It will be recognized and appreciated by those skilled in the art that modifications, variations and adaptations may be made to the embodiments described herein without departing from the scope or spirit of the invention. For instance, various embodiments may be adapted to accommodate for the management of various types of electronic data indicative of information pertaining to a product or products being transported between or among various nodes of a network. A network may be the chain of distribution of consumer goods, for example. Examples of nodes within such a network may include manufacturing or assembly facilities, distribution centers, shipping ports, import/export facilities, train stations, trucking facilities, warehouses, wholesale facilities, retail facilities, consignee facilities, repair facilities, workplaces, consumers' homes, construction sites and various other end user facilities. The nodes within the network may be connected by various modes of transportation such as rail, ship, truck or simply a consumer driving a personal vehicle, for example.

One exemplary embodiment of a method of the present invention allows for consumer-related and product-related information representing a commercial transaction to be managed over a telecommunications medium, such as the Internet for example, for the efficient delivery and return of a product or products associated with the transaction. Other telecommunications mediums may be used provided they are configured for the exchange of electronic data between or among nodes of a network. One aspect of the method allows for a barcode label to be affixed to a product or its container indicative of delivery and/or return information such as the product model and serial number and a return authorization number, for example. Other information may be included in the barcode such as consumer-related information or other information as desired. Another aspect of the present invention allows for the management of electronic data over a telecommunications medium for tracking product-related events such as shipment of the product from the manufacturer to a distribution point or retailer, for example. Other such product-related information may be managed electronically such as departure and arrival times of the product between a point of origin and a point of destination, whether the product needs to be backhauled after being returned by a consumer or whether a returned product is to be shipped to a dealer network for aftermarket sale to other end users.

Similarly, another aspect of the present invention allows for the management of electronic data over a telecommunications medium indicative of consumer-related information that may be associated with specific product-related information. For example, consumer-related information such as preferred times for delivery or pickup of the product(s), whether the consumer will pick the product(s) up them self or whether the consumer cancels or reschedules a delivery or pickup may be linked to specific product-related information for the efficient delivery and/or return of the product(s).

Another exemplary embodiment of a method of the present invention allows for the use of a portable computing device such as a handheld scanner or similar device for collecting and/or transmitting at least a portion of the product-related and/or consumer-related information. The device may include a data processing module for collecting, managing, transmitting and receiving over a telecommunications medium consumer-related and/or product-related information as well as other electronic data as desired. In one exemplary aspect of the invention a handheld scanner may be used as a data collection device to scan machine-readable barcodes expressing information pertaining to the delivery and/or return of a product or products. The data collected by the scanner may then be uploaded or otherwise transferred to a remote or centralized computerized system. The remote and/or centralized computerized system may be adapted to process the transferred data to update records, fields or data files stored on a database remote from the scanner that are associated with the transferred data. For example, the remote and/or centralized computerized system may be configured with a data processing module to update the inventory records of a delivery service center such as by changing the condition status of an inventoried product or products from “crated” to “uncrated” if a product is returned after being taken out of its shipping container.

One aspect of the present invention allows for a person delivering a product to scan a unique customer number to initiate the delivery. The delivery person may also determine whether all products to be delivered to a particular consumer are to be delivered in one shipment or more than one shipment. It also allows for the delivery person to scan data indicative of a consumer's decision to refuse acceptance of a product and the reason why the consumer has refused acceptance. Data may also be scanned indicative of the customer's decision to modify the scope of services, such as installation services, to be performed in association with the product being delivered or other products at the consumer's location. Another aspect of the present invention allows for the scanned date to be downloaded to a remote computer system at the delivery service center's location, for example. The data may then be transmitted from the remote computerized system over a telecommunications medium to a centralized computer system, which processes the data to update associated records, fields or data files.

Another aspect of the present invention allows for machine readable barcodes to be scanned associated with the return of a product or products. For example, one embodiment of the invention allows for a centralized computer system to generate a return authorization in response to a customer requesting that a product be returned to the point of origin such as a service center. The return authorization may include a bill of lading, a return authorization number and a printed return barcode label containing consumer-related and/or product related data. The return authorization may then be transmitted over a telecommunications medium or otherwise to a delivery service center responsible for scheduling that return and picking up the product to be returned. One aspect of the invention allows for a person picking up the product to input into the portable computing device a barcode expressing the return authorization number to initiate the return process. Such person may also input product-related data such as the product model and serial numbers, which may be expressed as barcodes on the return barcode label. The pickup person may compare the scanned numbers to the associated numbers on the product or products to be picked up to determine whether the pickup should be made. The person picking up the product may also input into the portable computing device a barcode or barcodes to enter other data associated with the return. For example, barcodes expressing data indicative of the reasons for the return such as the product being damaged, for example, may be scanned at the time of pickup. If damage is present, the pickup person may scan a barcode to enter data indicative of damage location and other damage related information. Alternatively, such information may be entered into the data processing module of the scanner or similar device by using a data entry keyboard or other appropriate data entry means.

Another aspect of a method of the present invention allows for the management of electronic data for crediting the consumer for the return of the product. For example, a data processing module may be provided on the remote and/or centralized computer system to verify that electronic data entered into the portable computing device during the return process, such as a product's model or serial number or other conditions for an authorized return, is correct. If the data is correct then the customer may be credited for the return. If the data is incorrect then the customer will be credited for the return when the data is corrected. In one exemplary embodiment of the invention, a handheld computing device, such as a scanner, may be configured to transmit and receive electronic data over the telecommunications medium so that errors in the return process may be detected at the time a product is being picked up. In this exemplary embodiment a purchaser returning a product may be credited at the time of pick up. Crediting the customer for a return means that all conditions for the authorized return of a product have been complied with. One exemplary embodiment of the present invention allows for a notification to be sent to a financial services group to make adjustments to a customer's invoice, if necessary, to account for the customer being credited for the return. This notification or a separate notification may also inform the financial services group that invoicing adjustments need to be made in response to data downloaded from the portable computing device to the centralized computerized system. For example, if during a delivery of a product a customer requests that services be performed that are not on the original customer order then the financial services group will be notified of that change and make adjustments for invoicing the customer to account for the change.

The exemplary embodiments of the present invention are advantageous in that they allow for the management of consumer-related and product-related information over a telecommunications medium for the efficient delivery and return of products pertaining to a consumer transaction. They also allow for the prompt crediting to a consumer for a product that has been returned.

### BRIEF DESCRIPTION OF THE DRAWINGS

FIG. 1 is a schematic of an exemplary computerized system that may be used for executing a method for managing electronic data indicative of information associated with the delivery and return of a product;

FIG. 2A illustrates a flow chart of one aspect of a method of the present invention;

FIG. 2B illustrates the flow chart of FIG. 2A continued;

FIG. 3A illustrates a flow chart of another aspect of a method of the present invention; and

FIG. 3B illustrates the flow chart of FIG. 3A continued.

### DETAILED DESCRIPTION OF THE INVENTION

FIG. 1 is a schematic of an exemplary computerized system 10 that may be used for executing a method for managing electronic data indicative of information associated with the delivery and return of a product between a point of origin and a point of destination. In accordance with one aspect of an exemplary embodiment of the present invention the point of origin may be any facility from which a good is to be shipped such as a manufacturer, warehouse or retail store, for example. Similarly, the point of destination may be any facility to which a good is to be shipped such as a warehouse, retail store, a customer's household or a construction site, for example. In one exemplary embodiment of the present invention, the point of origin may be a service center such as one that may be managed and operated by the assignee of the present invention and the point of destination may be a customer's household.

By way of example, the service center may include a computer server system 12 that includes a database 14 connected to a computer processor 16 that may manage electronic data indicative of information associated with the delivery and return of a product between a point of origin and a point of destination. The database 14 and computer processor 16 may be interoperably connected by virtue of a local or wide area network, for example. A portable computing device 18 may be provided. In one exemplary embodiment of the present invention the computing device 18 may be a handheld device such as a wireless handheld programmable computer suitably configured to read barcodes, execute machine readable programming code, store and manage electronic data, and transmit and receive electronic data over a telecommunications medium 20. Computing device 18 may also be configured with a commercially available Web browser capable of downloading and displaying Web pages if desired. A remote computer system 19 may be provided that is capable of executing programmable code, data processing and exchanging data over the telecommunications medium 20. The telecommunications medium 20 may be the Internet or other Web-enabled mediums, for example. As will be appreciated by those skilled in the art, the computer processor 16 and database 14 may reside on a single computer or they may be remote from each other. Also, computer processor 16 may be suitably configured with commercially available software to operate as a Web server if desired. The telecommunications medium 20 may allow for connectivity among the computer processor 16, the database 14, the computing device 18 and computer system 19 by way of a commercially available service provider 22. The service provider 22 may be any entity that enables transaction services in commerce and in one aspect of the present invention is a commercial Internet service provider.

In one aspect of an exemplary embodiment of the invention computer server system 12 may be a centralized system, such as a mainframe computer, that is interoperably connected via a telecommunications medium 20 with a plurality of computer systems 19 located remotely from the centralized system. In this respect, the centralized computer system may perform data processing functions and the remote computer systems may access database 14 using known techniques such as by connecting to the centralized system over the Internet and entering a user name and a password. In an alternate embodiment data processing functions may be performed by the remote computer systems rather than transmitting data to the centralized system for processing.

FIG. 1 also illustrates that a set of consumer-related data 30 and a set of product-related data 32 may be entered into database 14. Data entry may be accomplished by any conventional means such as a keyboard or voice activated commands, for example. Consumer-related data 30 and product-related data 32 may be entered, stored and managed on database 14 by using conventional techniques such as commercially available database management software executed by processor 16. Discrete records, fields or data files may be created for each consumer within the set of consumer-related data 30 and/or for each product within the set of product-related data 32. For example, discrete data files may be created for a particular consumer each time that consumer purchases a product or products. Such data file may contain consumer-related and product-related data indicative of a commercial transaction between a consumer and a manufacturer or retailer of a commercial product such as a home appliance, for example. Such data file may also include other information as desired by the service center pertaining to the commercial transaction. For example, a set of consumer preferences may be included in the data file such as whether the consumer desires home delivery, what time the delivery should be made or historical data indicative of that consumer's purchasing patterns.

Similarly, discrete records, fields or data files may be created, stored and managed on database 14 that may contain data indicative of product-specific information and/or events in a product's life-cycle. For example, when a product is manufactured a model number and/or a serial number, or another unique identification code for that product, may be created and assigned to that product for identification and/or for tracking that product through its life cycle. In one exemplary embodiment of the present invention, unique model and serial numbers may be generated for each product. The model and serial numbers may be permanently affixed to the associated product. Barcode labels may also be created that contain the model and serial numbers expressed as barcodes. The label may be affixed to the outside surface of a product container or other packaging for ease of scanning as the product moves through distribution channels. Such barcodes may be generated using commercially available software that may be read by the portable computing device 18.

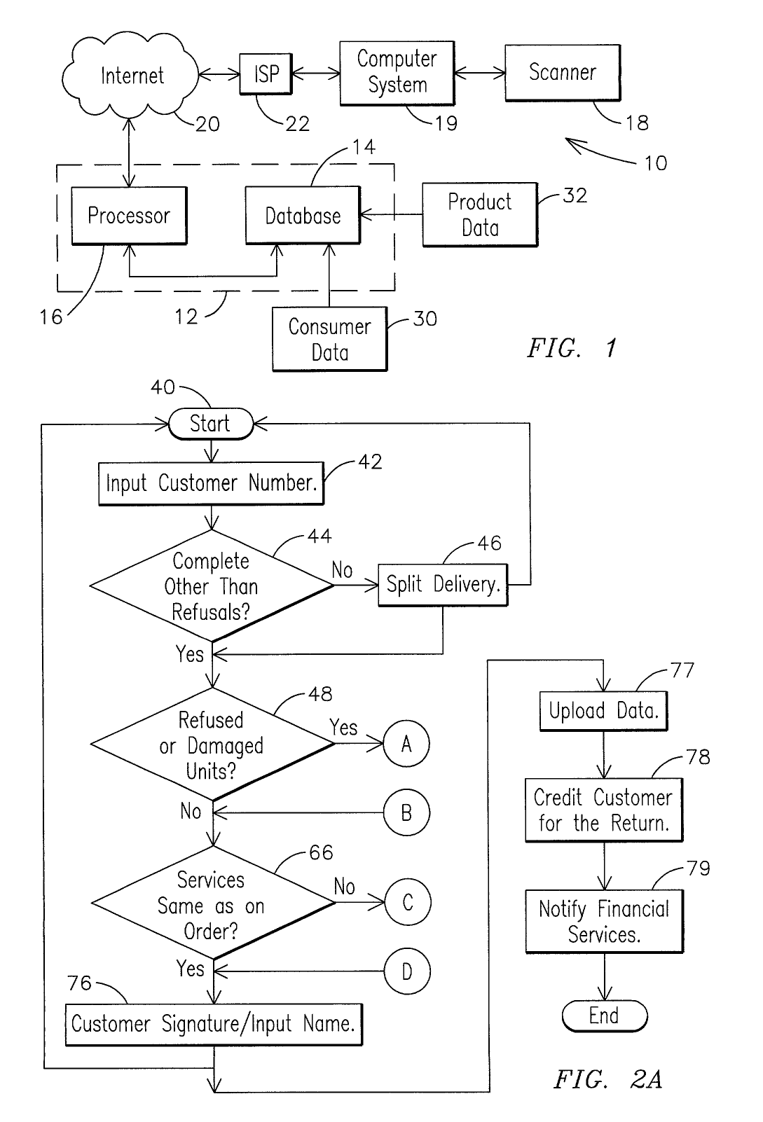

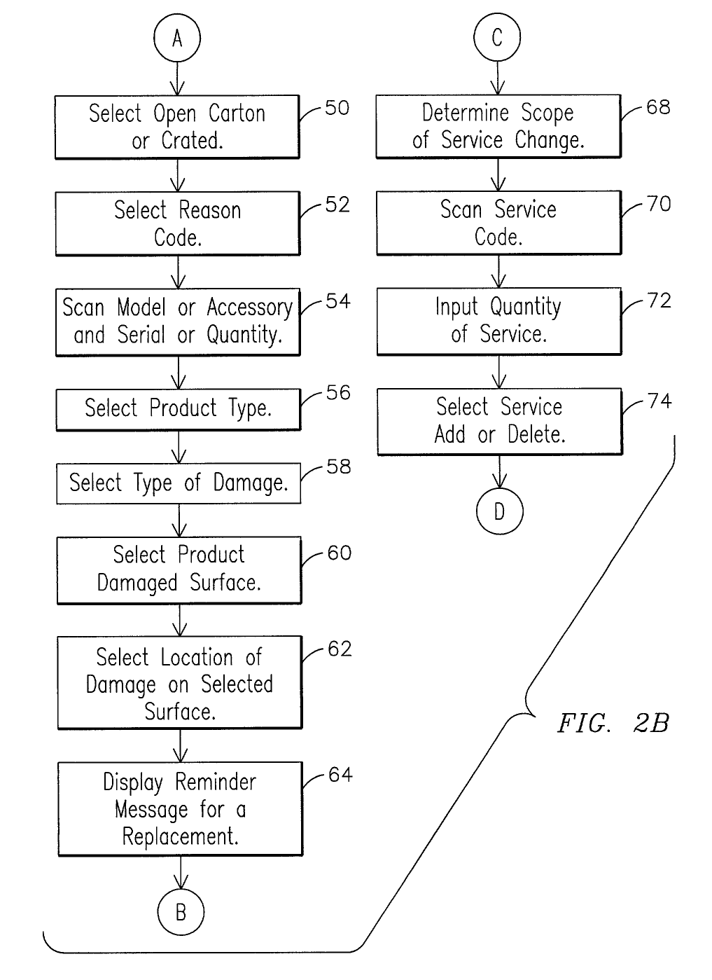

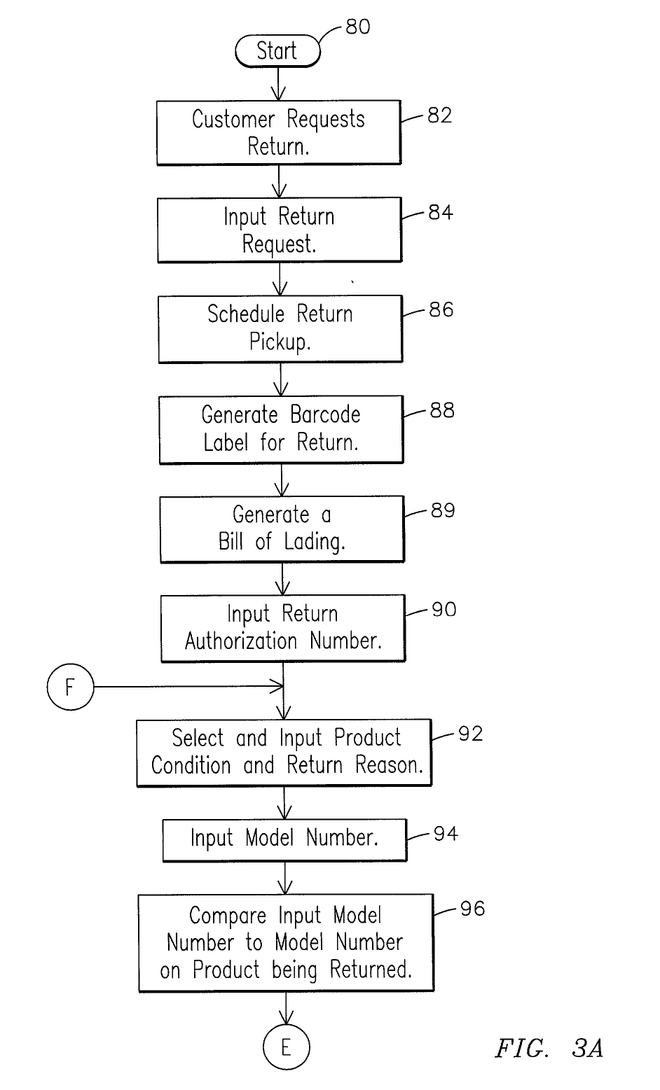

Another aspect of the present invention allows for the creation of a unique customer identification number that may be associated with certain consumer-related data and/or certain product-related data indicative of a commercial transaction such as the customer purchasing a home appliance, for example. The unique customer identification number may also be associated with information specific to a delivery or return of product or products associated with that customer number. As shown in FIG. 2A, in one exemplary embodiment of a method of the present invention, after start step 40, step 42 allows for the unique customer number to be entered into computing device 18 and stored as a data file. The unique customer number may be entered into computing device 18 manually by using a keypad or other input means integral to computing device 18. In another exemplary embodiment the unique customer number may be expressed as a barcode and scanned into the computing device 18. One aspect of the present invention allows for the unique customer number to be used by a delivery person when delivering a product from a point of origin, such as a retail store outlet, to a point of destination such as a customer's home. For example, step 42 allows for the delivery person to scan the unique customer number into computing device 18 when the delivery person is preparing to deliver a product or products to a customer. In one embodiment of the present invention, the unique customer number may be the bill of lading number associated with a product being delivered. The bill of lading number may be found on the product's container or packing material expressed in numeric and barcode format and may be part of the product-related data 32.

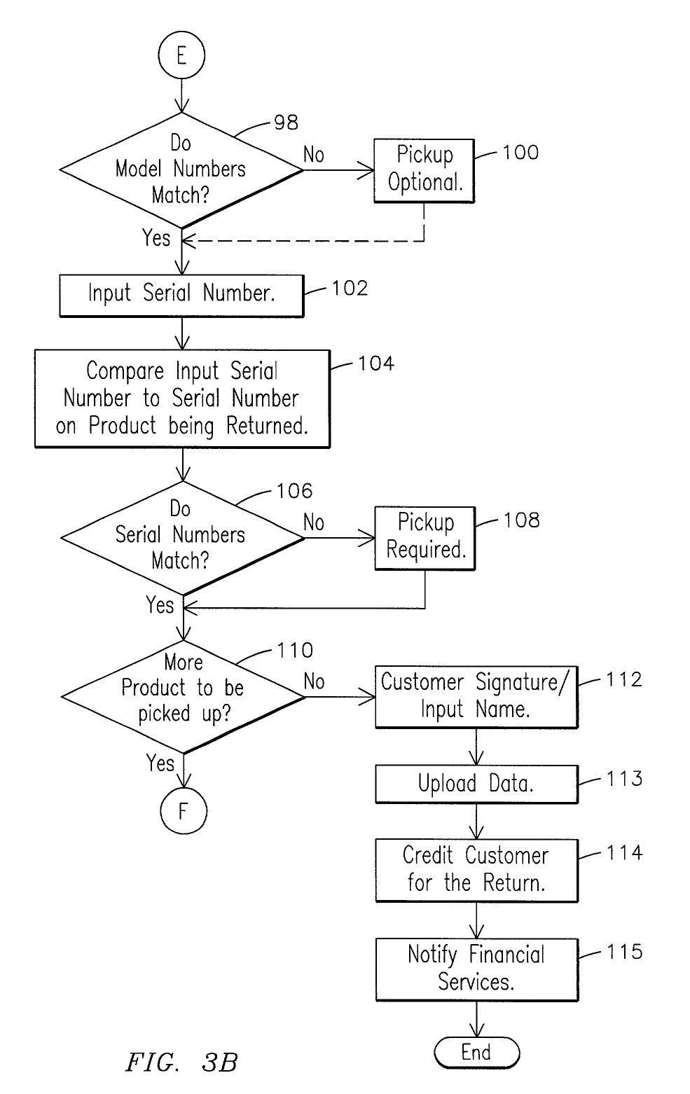

In another aspect of the present invention, computing device 18 may be loaded with executable programming code to allow for the computing device 18 to acquire or download data, such as consumer-related data, product-related data or data specific to a delivery or return, for example, in association with the unique customer number entered into the device. For example, for each unique customer number entered into the device, the device may acquire additional data associated with that number such as data indicative of a response to the questions asked in steps 44, 48, 66 and 76 shown in FIG. 2A. Computing device 18 may also acquire data associated with a unique customer number such as data indicative of the categories of information identified in steps 50 through 62 and 68 through 74 shown in FIG. 2B, steps 90 through 94 shown in FIG. 3A, and steps 102 and 112 shown in FIG. 3B, for example. Other associated data may be entered as desired. Such data may be entered manually using a keypad on computing device 18 or otherwise loaded into a memory device of computing device 18 using know techniques. In one exemplary embodiment of the present invention the data acquired by computing device 18 is expressed as barcodes that are scanned by the device.

As shown in FIG. 2A, one embodiment of a method of the present invention allows, in step 44, for a delivery person, for example, to determine whether all products associated with a customer order are to be delivered that day or whether there will only be a partial delivery that day. If only a partial delivery, a split delivery may be created in step 46 and another delivery date may then be scheduled for the product or products in the split delivery. If all products associated with the customer order are to be delivered that day then the data file associated with that delivery may be flagged as a completed order. One aspect of the present invention allows for data indicative of whether the delivery person is to make a split delivery that day to be acquired by the computing device 18 such as by having the delivery person enter data indicative of a response to a question generated by executable code of the device.

FIG. 2A illustrates another aspect of the present invention at step 48. When the delivery person arrives at a point of destination, such as a customer's household for example, step 48 allows for the delivery person to enter data into the computing device 18 indicative of whether the customer refuses to accept a product or products due to damage or for other reasons. A customer's refusal to accept a product constitutes a return of that product. For each product a customer refuses, one embodiment of the present invention allows for the delivery person to enter data into the computing device 18 indicative of information associated with each product being refused for return. Such data, as well as any other data entered into computing device 18, may be entered by scanning a barcode expressing the specific data to be entered, the data may be entered manually or it may be entered by having the delivery person respond to a series of questions generated by executable programming code contained in a computer processing module of computing device 18. For example, FIG. 2B illustrates various steps of one exemplary embodiment of the present invention. Step 50 allows for entering data indicative of whether the product being refused is still in its shipping container or other packing carton or whether it has been removed. Step 52 allows for selecting and entering a reason code indicative of the reason why the customer has refused acceptance of the product. Step 54 allows for entering data indicative of a refused product's model or accessory number and serial number or quantity. Step 56 allows for selecting and entering data indicative of a refused product type. Step 58 allows for selecting and entering data indicative of damage to a refused product. Step 60 allows for selecting and entering data indicative of a refused product's damaged surface. Step 62 allows for selecting and entering data indicative of the location of damage to a refused product and step 64 allows for the computing device 18 to display a message reminding the delivery person that a replacement product may be necessary for the returned product.

Another aspect of the present invention allows for computing device 18, or a separate device carried by a delivery person, to be configured with appropriate hardware and software for generating and printing a return barcode label that may be affixed to the product or products being refused. In this respect, a delivery person may generate a return barcode label at the time a delivered product is refused.

Another aspect of the present invention allows for, in step 66 shown in FIG. 2A, the delivery person to determine whether the customer at the point of destination desires to have the same services performed at the time of delivery as those described on an associated customer order or whether the customer desires to change the scope of those services. If the customer desires to change the scope of services, step 68 shown in FIG. 2B allows for the delivery person to determine whether more or less services will be performed relative to those on the customer order. Once determining the scope of services change, step 70 allows for selecting and entering data indicative of the scope of services change, such as an installation or service code associated with a specific type of service, and whether a service is being added to or deleted from the scope of services described in the customer order. Step 72 allows for selecting and entering data indicative of a quantity associated with each entered installation or service code and whether that quantity is being added to or deleted from the scope of services described in the customer order. Step 74 allows for selecting and entering data indicative of whether the services and quantity entered in steps 70 and 72 are to be added to the customer order or deleted from the customer order, which may result in a change of cost to the customer.

Another aspect of the present invention allows for, in step 76 shown in FIG. 2A, the delivery driver to acquire the customer's signature with the portable computing device 18. Computing device 18 may be configured with commercially available hardware and software to electronically capture, store and manage data indicative of cursive writing such as a customer's signature. Step 76 also allows for the delivery driver to enter data into the computing device 18 indicative of the customer's last name. Step 77 allows for data entered into computing device 18 to be uploaded or otherwise transmitted to computer system 12 via telecommunications medium 20 or other conventional methods. Processor 16 may execute a software application for updating records, fields or data files on database 14 associated with the uploaded data from computing device 18. For example, database 14 may contain a set of fields that correspond to the data input into the portable computing device 18 in response to steps 44 through 74. The fields may be automatically updated or populated with the data when it is received by the computer system 12. Another aspect of the present invention allows for a customer to be credited for a refused product or products in step 78. A customer may be credited for a return when all conditions for an authorized return are met. A notification may be sent in step 79 to a financial services group informing that group that a customer has been credited for a return. The financial services group may make any necessary financial adjustments to account for the customer being credited for a return. Similarly, a notification sent in step 79 may also inform the financial services group of changes requested by a customer that are different from those on an original customer order. For example, if a customer changes the scope of services in step 66 then the financial services group may be notified of that change and make any necessary invoicing adjustments to that customer. Once delivery at a point of destination has been completed by obtaining a customer signature in step 76 of FIG. 2A, one exemplary embodiment of the present invention allows for the delivery person to return to step 40 and initiate a next delivery, which may be repeated.

One exemplary embodiment of a method of the present invention allows for the management of electronic data indicative of consumer-related and/or product-related information for returning a product. As shown in FIG. 3A, after start step 80, step 82 allows for a customer to submit a request to a service center, for example, that a product be picked up for a return. Upon receiving the request, step 84 allows for data indicative of the return request to be input into the computer system 12. The data indicative of the return request may be input into a new data file or it may be entered into an existing file that may contain or be linked with another data file or files that may contain consumer-related data 30 and/or product-related data 32. Step 86 allows for a return pickup to be scheduled. Computer system 12 and/or computer system 19 may be loaded with commercially available software adapted for scheduling the return pickup. Computer system 12 and/or computer system 19 may also be loaded with commercially available software adapted for the generation and printing of barcodes and barcode labels that may be scanned by computing device 18. One aspect of the present invention allows for, in step 88, a return barcode label to be generated that may be affixed over a delivery barcode label if one is present on a product to be returned or on that product's container or packaging. If no delivery barcode is present then the return barcode label may be affixed to the product to be returned in its “as is” condition. The return barcode label may contain the model and serial number of a product to be returned along with a return authorization number associated with a product or products to be returned. The model, serial and return authorization numbers may be expressed numerically and/or in barcode format on the return barcode label. A return bill of lading may also be generated in step 89 by computer system 12 and/or computer system 19 that may contain product-related, consumer-related and other information pertaining to the product or products being returned.

Step 90 allows for entering data into the computing device 18 indicative of the return authorization number, which may be scanned into the device. A return module software application may be loaded on computer system 12 and/or computing device 18 and it may be initiated when the authorization number is entered. In an alternate aspect of the invention, the executable code of the return module software application may reside on a Web based server of computer system 12 that is configured to enable transmission of or access to the executable code, such as over the telecommunications medium, for example, as in an Application Service Provider model.

Step 92 allows for, in one aspect of the invention, selecting and inputting data indicative of the condition of each product being returned and the reason for the return into computing device 18. If a product is being returned due to damage, for example, then steps 56 through 64 shown in FIG. 2B may be repeated for each product being returned. Similarly, if a customer requests a scope of services change during a return steps 68 through 74 may be executed. If a product is being returned for reasons other than damage, such as a customer changing their mind, then step 92 allows for data indicative of such reasons to be entered into computing device 18. The reason codes entered in step 92 may be the same as those entered in step 52. Step 94 allows for data indicative of the model number for each product being returned to be entered into computing device 18. The model number entered in step 94 is the same as the model number on the return barcode label generated in step 88. One aspect of the present invention allows for, in step 96, the model number entered into computing device 18 to be compared to the model number found on the product to be returned. If the model numbers do not match as asked in step 98 then picking up the product for a return is optional as shown in step 100. If the model numbers do not match and the product is to be returned another aspect of the present invention allows for the input of data indicative of the serial number for each product being returned to be entered into the computing device 18 as shown in step 102. The serial number entered in step 102 is the same as the serial number on the return barcode label generated in step 88. Another aspect of the present invention allows for, in step 104, the serial number entered into the computing device 18 to be compared to the serial number found on the product to be returned. If the serial numbers do not match as asked in step 106 then the pickup of the product may be required as shown in step 108. Step 110 allows for returning to step 92 for each additional product being returned under a return authorization number. When all products are prepared for return, step 112 allows for the customer's signature to be acquire by computing device 18 and data indicative of the customer's last name to also be entered into the device. Step 113 allows for data entered into computing device 18 to be uploaded or otherwise transmitted to computer system 12 via telecommunications medium 20 or other conventional methods. Processor 16 may then update or populate records, fields or data files contained on database 14 that are associated with the uploaded data.

Another aspect of the present invention allows for the consumer to be credited for the return in step 114. Crediting the consumer for the return means that all conditions for an authorized return of a product have been met. Such conditions may be established by a service center and may vary depending on the circumstances. Step 115 allows for a notification to be sent to a financial services group to inform them that a customer has been credited for a return. The financial services group may make any necessary invoicing adjustments to the customer as determined by the group in response to the records, fields or data files contained on database 14 being updated or populated with the data entered into computing device 18 and transmitted to the computer system 12.

The present invention can be embodied in the form of computer-implemented processes and apparatus for practicing those processes. The present invention can also be embodied in the form of computer program code including computer-readable instructions embodied in tangible media, such as floppy disks, CD-ROMS, DVDs, hard drives, or any other computer-readable storage medium, wherein when the computer program code is loaded into and executed by a computer(s), the computer(s) becomes an apparatus for practicing the invention. When implemented on a computer(s), the computer program code segments configure the computer(s) to create specific logic circuits or processing modules.

While the invention has been shown and described in what is presently considered to be a preferred embodiment, many variations and modifications will become apparent to those skilled in the art. Accordingly, it is intended that the invention not be limited to the specific illustrative embodiments, but be interpreted with the full spirit and scope of the appended claims.

What is claimed is:

1. A method for managing electronic data over a telecommunications medium indicative of information pertaining to the transport of a product between a point of origin and a point of destination comprising the steps of:
providing a database containing consumer-related and product-related information associated with the product, the database being accessible by a computer server system;
inputting into a portable computing device electronic data indicative of a unique customer number associated with the transport of the product between the point of origin and the point of destination, the portable computing device being capable of scanning barcodes;
inputting into the portable computing device electronic data indicative of a reason code if the product is being returned;
transmitting over the telecommunications medium to the computer server system at least a portion of the electronic data input into the portable computing device; and
updating the database with the transmitted electronic data.

2. The method of claim 1 further comprising:
inputting into the portable computing device electronic data indicative of a product type code associated with the product; and
inputting into the portable computing device electronic data indicative of at least one code indicative of damage information associated with the product if the product is damaged.

3. The method of claim 2, the step of inputting data indicative of at least one code indicative of damage information comprising the step of inputting into the portable computing device electronic data indicative of at least one of:
a code indicative of damage type; and
a code indicative of surface type; and
a code indicative of damage location types.

4. The method of claim 1 further comprising the steps of:
determining whether a delivery is a split delivery; and
scheduling a second delivery if the delivery is a split delivery.

5. The method of claim 1 further comprising the steps of:
crediting a customer for a return of the product; and
notifying a financial services group that a customer has been credited for the return of a product.

6. The method of claim 1, further comprising the step of:
inputting into the portable computing device data indicative of a service code.

7. The method of claim 6 further comprising the step of:
inputting into the portable computing device data indicative of a quantity associated with the service code;
inputting into the portable computing device data indicative of a change in cost associated with the service code; and
notifying a financial services group of the change in cost.

8. The method of claim 1 further comprising the step of:
generating a delivery barcode label to be affixed to at least one of the product and a container for the product, the delivery barcode label including at least one barcode expressing data indicative of the unique customer number, a model number for the product and a serial number for the product.

9. The method of claim 1 further comprising the steps of:
inputting into the computer server system a customer request for a return of the product; and
generating at least one return barcode label to be affixed to at least one of the product and a container for the product, the return barcode label including at least one barcode expressing data indicative of a return authorization number, a first model number for the product and a first serial number for the product.

10. The method of claim 9 further comprising the steps of:
inputting into the portable computing device data indicative of the return authorization number;
inputting into the portable computing device data indicative of the first model number;
comparing the first model number to a second model number affixed to the product; and
determining whether a return of the product should be made if the first model number does not match the second model number.

11. The method of claim 10 further comprising the steps of:
inputting into the portable computing device data indicative of the first serial number;
comparing the first serial number to a second serial number affixed to the product; and
picking up the product being returned if the first serial number does not match the second serial number.

12. The method of claim 9 further comprising the steps of:
inputting into the portable computing device data indicative of a customer's signature and data indicative of the customer's last name displayed as text.

13. The method of claim 2 further comprising the steps of:
inputting into the computer server system a customer request for a return of the product; and
generating a return barcode label to be affixed to at least one of the product and a container for the product, the return barcode label including at least one barcode expressing data indicative of a return authorization number, a first model number for the product and a first serial number for the product.

14. A method for managing electronic data over a telecommunications medium, the data indicative of customer-related and product-related information pertaining to the delivery and return of a product between a service center and a customer's site, the method comprising the steps of:
storing electronic data indicative of consumer-related and product-related information in a database of a computer server system;
associating a unique customer number with the product;
inputting the unique customer number into a portable computing device capable of reading barcodes;
inputting a reason code into the portable computing device if the customer refuses delivery of the product;
inputting a reason code into the portable computing device if the customer has requested a return of a product;
uploading data from the portable computing device over the telecommunications network to the database of the computer server system; and
updating the database of the computer server system with the uploaded data.

15. The method of claim 14 further comprising the steps of:
inputting a product type code into the portable computing device if the product is being returned; and
inputting at least one code into the portable computing device indicative of damage information associated with the product if the product is being returned due to damage.

16. The method of claim 15, the step of inputting at least one code indicative of damage comprising the step of inputting at least one of:
a code indicative of damage type; and
a code indicative of surface type; and
a code indicative of damage location types.

17. The method of claim 14 further comprising the steps of. inputting into the portable computing device data indicative of a service code if the customer requests a change of service; and
inputting into the portable computing device data indicative of a change of cost associated with the change of service.

18. The method of claim 14 further comprising the steps of:
crediting a customer for a return of the product; and
notifying a financial services group that a customer has been credited for the return of a product.

19. The method of claim 14 further comprising the steps of:
inputting into the portable computing device a return authorization number associated with the return of the product if the customer has requested the return of the product;
generating at least one return barcode label if the customer has requested the return of the product, the return barcode label including at least one barcode expressing data indicative of the unique customer number, a first model number for the product and a first serial number for the product;
affixing the return barcode label to at least one of the product and a container for the product; and
covering a delivery barcode label with the return barcode label if the delivery barcode label is affixed to at least one of the product and the container for the product.

20. A system for efficiently managing the transport of a product between a point of origin and a point of destination comprising:
a centralized computer server system capable of transmitting and receiving data over a telecommunications medium;
a database accessible by the centralized computer server system containing at least one of consumer-related information and product-related information associated with the transport of the product;
a processor operable to update the database with data received over the telecommunications medium;
a computer system situated remote from the centralized computer server system, the computer system capable of exchanging data with the centralized computer server system over the telecommunications medium; and
a portable computing device capable of collecting and storing electronic data by scanning barcodes, the portable computing device capable of downloading electronic data to the computer system.

21. The system of claim 20 further comprising at least one of:
a delivery barcode label affixed to at least one of the product and a container for the product, the delivery barcode label including at least one barcode expressing data indicative of the unique customer number, a model number for the product and a serial number for the product; and
a return barcode label affixed to at least one of the product and a container for the product, the return barcode label including at least one barcode expressing data indicative of a return authorization number, a model number for the product and a serial number for the product.

22. The system of claim 20 further comprising:
a set of reason codes expressed as a first set of barcodes and adapted to be transported with a person transporting the product between the point of origin and the point of destination, the first set barcodes comprising a plurality of barcodes expressing data indicative of a plurality of reasons why a customer may refuse to accept a delivered product and why a customer may return a product.

23. The system of claim 20 further comprising:
a set of product type codes expressed as a second set of barcodes and adapted to be transported with a person transporting the product between the point of origin and the point of destination, the second set of barcodes comprising a plurality of barcodes expressing data indicative of a plurality of product types.

24. The system of claim 20 further comprising:
a set of damage type codes expressed as a third set of barcodes and adapted to be transported with a person transporting the product between the point of origin and the point of destination, the third set of barcodes comprising a plurality of barcodes expressing data indicative of a plurality of damage types associated with the product.

25. The system of claim 24 further comprising:
a set of damage location codes expressed as a fourth set of barcodes and adapted to be transported with a person transporting the product between the point of origin and the point of destination, the fourth set of barcodes comprising a plurality of barcodes expressing data indicative of a plurality of damage locations associated with the product.

26. The system of claim 25 further comprising:
a set of damage surface codes expressed as a fifth set of barcodes and adapted to be transported with a person transporting the product between the point of origin and the point of destination, the fifth set of barcodes comprising a plurality of barcodes expressing data indicative of a plurality of damage surfaces associated with the product.

27. The system of claim 20 further comprising:
a set of service codes expressed as a sixth set of barcodes and adapted to be transported with a person transporting the product between the point of origin and the point of destination, the sixth set of barcodes comprising a plurality of barcodes expressing data indicative of a plurality of services that may be performed at the point of destination.
